(19) United States
(12) Patent Application Publication
(10) Pub. No.: US 2013/0291527 A1
(43) Pub. Date: Nov. 7, 2013

(54) Hydraulic Power Control System and Method

(71) Applicants: Christopher M. Elliott, Apex, NC (US); Paul Anthony Dvorak, Sanford, NC (US)

(72) Inventors: Christopher M. Elliott, Apex, NC (US); Paul Anthony Dvorak, Sanford, NC (US)

(73) Assignee: CATERPILLAR INC., Peoria, IL (US)

(21) Appl. No.: 13/465,536

(22) Filed: May 7, 2012

(51) Int. Cl. F16D 31/00

(52) U.S. Cl. 60/327; 60/459

(57) ABSTRACT

A method and apparatus for controlling a hydraulic power system that includes a hydraulic motor and a hydraulic pump configured to supply hydraulic fluid to the hydraulic motor is provided. A relief valve is provided that is configured to release hydraulic fluid from a location between the hydraulic pump and the hydraulic motor when a pressure of the hydraulic fluid exceeds a predetermined pressure. A controller is in communication with the hydraulic motor and the hydraulic pump. The controller is configured to determine a first hydraulic fluid flow across the relief valve and determine a desired maximum flow across the relief valve. The controller also can regulate one or both of the hydraulic pump and the hydraulic motor to control the first hydraulic fluid flow based on the desired maximum flow.

### TECHNICAL FIELD

This patent disclosure relates generally to hydraulic power control systems and methods and, more particularly to systems and methods of controlling hydraulic power systems using non-productive flow control.

### BACKGROUND

Machines may include one or more hydraulic power systems to drive one or more loads. The load may be a work implement on the machine or it may be a drive component that provides propulsion for the machine itself For example, in a machine drive train, a hydraulic power system, also known as a hydrostatic transmission, may be used in lieu of a mechanical transmission.

A hydraulic power system may include a variable displacement hydraulic pump and a hydraulic motor, which may also have variable displacement, that are connected together in a closed loop configuration. Fluid pumping through the hydraulic motor can cause it to spin an output shaft to thereby move a load such as a drive mechanism, such as a wheel or track, or a work implement. By varying the displacement of the pump, the amount of fluid pumped to the hydraulic motor may be controlled. This can be in response to a received operator input. For example, when an operator depresses an accelerator pedal to indicate a desire for more speed or torque of a drive mechanism, a discharge of the pump (flow and/or pressure) is proportionally increased.

To protect components of the transmission from damage, operation of the pump and/or motor is commonly limited according to pressure. Pressure may build in a hydraulic power system that functions to power the drive mechanism of a machine when the machine encounters an external resistance such as when pushing on something that is heavy or substantially immovable, like a large pile of earth. When the machine meets the resistance of the large pile of earth, the forward travel of the machine may be slowed or stopped, which, in turn, slows or stops the hydraulic motor that drives the drive mechanism. This substantially inhibits the flow of fluid through the motor. However, the variable displacement pump may continue to pump fluid to the hydraulic motor resulting in a build-up of pressure in the system.

One way to relieve this kind of pressure build up is with a cross-over relief (COR) valve, which may permit hydraulic fluid to flow (i.e., cross over) from the high pressure side of the circuit over to the low pressure side. While a COR valve can prevent spikes in pressure, continued flow across a COR valve can cause significant heating of the hydraulic fluid due to the pressure drop of the fluid as it passes from the high pressure side to the low pressure side of the system. Moreover, flow across a COR can be an inefficient use of energy since the flow through the valve is not productive, that is, not being used in a productive manner, such as, for example to turn the hydraulic motor.

Another common way to provide pressure relief is with an electronic pressure override (EPOR) system. An EPOR system senses system pressure and acts to reduce the displacement of the variable displacement pump, and thus reduce the amount of fluid being pumped to the hydraulic motor (or implement actuator), when the pressure exceeds a certain amount. Many hydraulic systems include EPOR systems in addition to COR valves.

An example of an EPOR system with COR is disclosed in U.S. Pat. No. 6,202,411 (the '411 patent). The '411 patent discloses a system that adjusts the discharge flow rate of a hydraulic pump when the system is held at a predetermined pressure for a predetermined period of time and when a specific operational condition of the system is sensed. Some of the disclosed operational conditions include use of a specific type of work implement, a high revolution condition of the engine and an operator selected work mode.

While effective to reduce pressure in the system, EPOR systems that are based on pressure control can be difficult to tune in a way that yields a consistent, intuitive feel to an operator of the machine. In particular, since the pressure control can be quite sensitive, when the EPOR system activates to reduce the pressure in a system, it can overshoot and to an operator it can feel as though the machine has suddenly stopped pushing. Moreover, an EPOR system based on pressure control can be relatively stiff to control and must be set to a pressure that is less than the upper limit of the system meaning that the machine may produce less than its maximum capable performance.

### SUMMARY

The disclosure describes, in one aspect, a hydraulic power control system for a machine. The system includes a hydraulic motor and a hydraulic pump configured to supply hydraulic fluid to the hydraulic motor. A relief valve is provided that is configured to release hydraulic fluid from a location between the hydraulic pump and the hydraulic motor when a pressure of the hydraulic fluid exceeds a predetermined pressure. A controller is in communication with the hydraulic motor and the hydraulic pump. The controller is configured to determine a first hydraulic fluid flow across the relief valve and determine a desired maximum flow across the relief valve. The controller also can regulate one or both of the hydraulic pump and the hydraulic motor to control the first hydraulic fluid flow based on the desired maximum flow.

In another aspect, the disclosure describes a method of controlling a hydraulic power system for a machine. The method includes the step of releasing hydraulic fluid from a location between a hydraulic pump and a hydraulic motor when the pressure of the hydraulic fluid exceeds a predetermined threshold pressure. A first flow of released hydraulic fluid is monitored. A desired maximum flow of released hydraulic fluid is determined and one or both of the hydraulic pump and the hydraulic motor is regulated to control the first flow based on the desired maximum flow.

### BRIEF DESCRIPTION OF THE DRAWINGS

FIG. 1 is a schematic side view of a track type machine suitable for use with the apparatus and method according to the present disclosure.

FIG. 2 is a schematic illustration of a hydraulic power system and associated control system according to the present disclosure.

FIG. 3 is a schematic flow diagram illustrating a hydraulic power control method according to the present disclosure.

FIG. 4 is a simplified exemplary plot of fluid flow across a hydraulic relief valve versus time for the temperature of the hydraulic fluid to reach an given undesirable level for a given sump temperature.

FIG. 5 is a schematic side view of a vibratory machine suitable for use with the apparatus and method according to the present disclosure.

### DETAILED DESCRIPTION

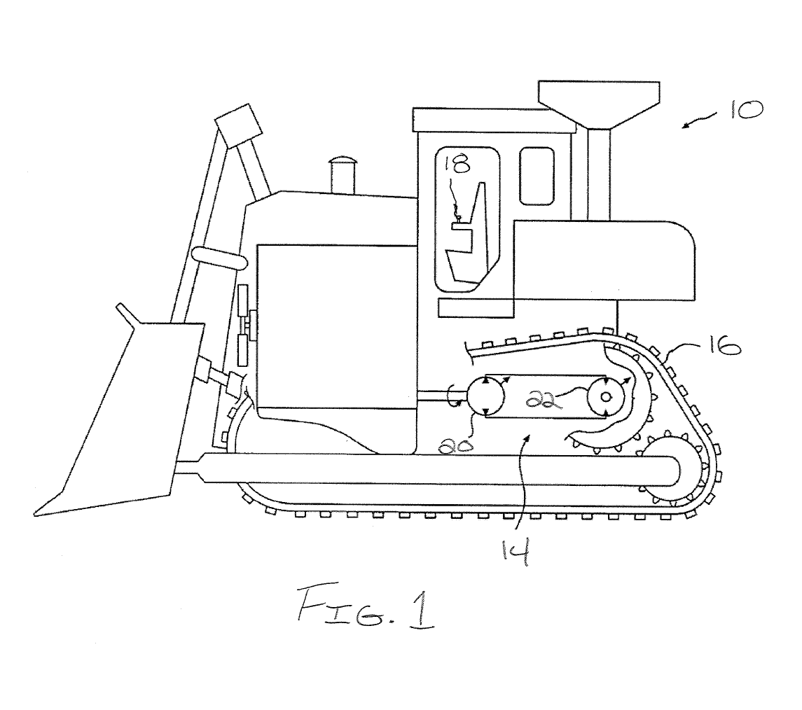

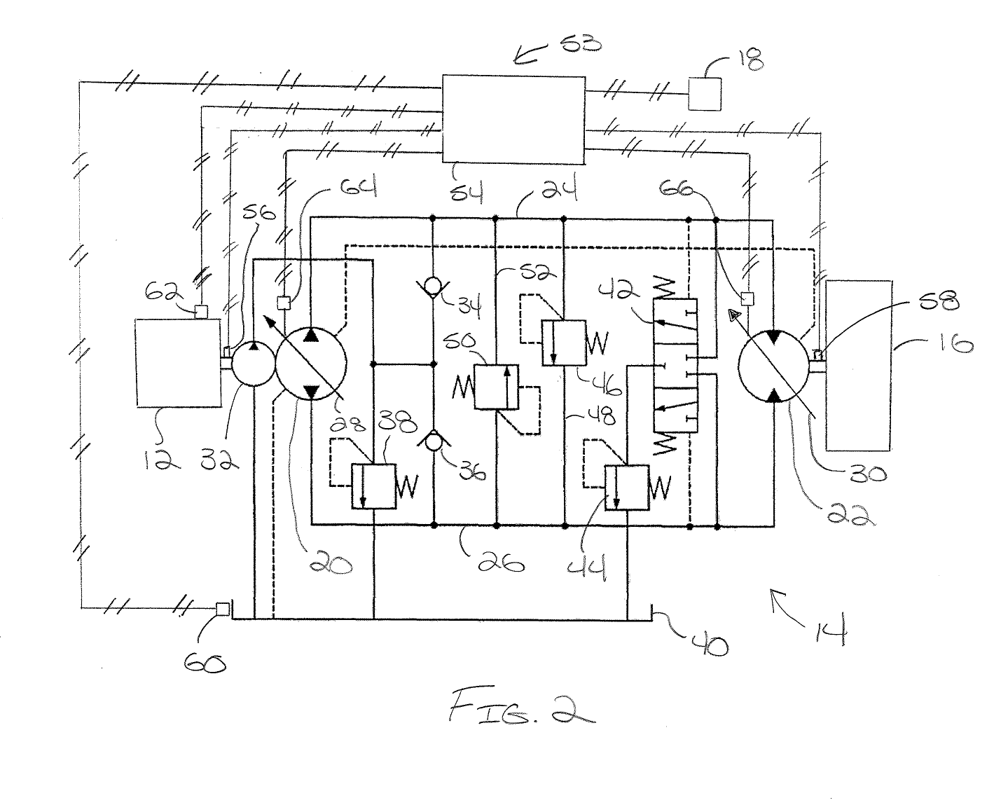

This disclosure relates to an apparatus and method for controlling a hydraulic power system for a machine that may be operable to transmit power to a load associated with the machine. With particular reference to FIGS. 1 and 2, an exemplary machine 10 having a power source 12 (see FIG. 2) and a hydraulic power system 14 that, in this case, transmits power from the power source 12 to a load, in this case traction devices 16, that propel the machine in response to an input received via operator input device 18. It should be noted that, although only one hydraulic power system and one traction device are illustrated in FIG. 1, the machine 10 may typically include two hydraulic power systems and two traction devices arranged into two substantially identical drive trains that can be powered by the power source 12 and independently controlled by way of a single or multiple operator input devices 18.

While the hydraulic power system 14 is illustrated in connection with a track type tractor, the arrangement disclosed herein has universal applicability in various other types of machines as well. In this regard, the term “machine” may refer to any machine that performs some type of operation associated with an industry such as mining, construction, fanning, transportation, or any other industry known in the art. For example, the machine 10 may be an earth-moving machine, such as a wheel loader, excavator, dump truck, backhoe, motor grader, material handler or the like. Moreover, the hydraulic power system 14 may be used to transmit power to other loads as well such as, for example, an implement that is connected to the machine. Such implements may be utilized for a variety of tasks, including, for example, loading, compacting, lifting, brushing, and include, for example, buckets, compactors, forked lifting devices, brushes, grapples, cutters, shears, blades, breakers/hammers, augers, and others.

The power source 12 may be configured to produce a power output and may include an internal combustion engine. For example, the power source 12 may include a diesel engine, a gasoline engine, a gaseous fuel-powered engine, or any other type of engine apparent to one skilled in the art. It is contemplated that the power source 12 may alternatively embody a non-combustion source of power such as a fuel cell, a battery, or an electric motor, if desired. The power source 12 may produce a rotational mechanical output received by the hydraulic power system 14.

The traction device 16 may embody a track located on a side of the machine 10. When two drive trains are included within the machine 10, the two associated traction devices 16 may be located on opposing sides of the machine 10 and simultaneously controlled to propel the machine 10 or independently controlled to steer the machine 10. Alternatively, the traction device 16 may embody a wheel, a belt, or any other driven traction device.

The operator input device 18 may be located within an operator station of the machine 10, for example, in close proximity to an operator's seat as shown in FIG. 1. The operator input device 18 may embody any one of numerous devices that control functions of the machine 10. In one example, the operator input device 18 may embody a joystick controller. It is contemplated, however, that operator input device 18 may embody additional or different control devices such as, for example, pedals, levers, switches, buttons, wheels, and other control devices known in the art. The operator input device 18 may be manipulated to generate signals indicative of a desired output of the hydraulic power system 14 (i.e., a desired travel speed, rimpull torque, and/or travel direction of the machine 10). In one example, a single operator input device 18 may be used to simultaneously control the movement of multiple traction devices 16. In another example, multiple operator input devices 18 may be used to independently control the movement of multiple traction devices 16.

With additional reference to FIG. 2, the hydraulic power system 14 may include a hydraulic pump 20 and a hydraulic motor 22 coupled in a closed loop hydraulic configuration (i.e., the hydraulic power system 18 may be a hydrostatic transmission). The pump 20 may be mechanically driven by the power source 12, while the motor 22 may mechanically drive the traction device 16. A first passageway 24 may direct pressurized fluid discharged from the pump 20 to the motor 22. A second passageway 26 may return used fluid from the motor 22 to the pump 20. It is contemplated that, in some embodiments, the functions of the first and second passageways 24, 26 may be reversed to thereby reverse the travel direction of the traction device 16, if desired.

The pump 20 may be a swashplate-type pump and include multiple piston bores, and pistons held against a tiltable swashplate 28. The pistons may reciprocate within the piston bores to produce a pumping action as the swashplate 28 rotates relative to the pistons. The swashplate 28 may be selectively tilted relative to a longitudinal axis of the pistons to vary a displacement of the pistons within their respective bores. The angular setting of the swashplate 28 relative to the pistons may be carried out by any actuator known in the art, for example, by a servo motor. Although shown in FIG. 1 as producing only a unidirectional flow of pressurized fluid, it is contemplated that the pump 20 may be an over-center type pump or rotatable in opposing directions to produce flows of fluid in opposing directions, if desired.

The motor 22 may be a fixed or variable displacement type motor fluidly coupled to the pump 20. The motor 22 may convert the pressurized fluid from pump 20 into a rotational output of traction device 16. As a variable displacement motor, the motor 22 may include multiple piston bores and pistons (not shown) held against a fixed or rotatable swashplate 30. The angle of the swashplate 30 may determine an effective displacement of the pistons relative to the bores of the motor 22. The angular setting of the swashplate 30 relative to the pistons may be carried out by any actuator known in the art, for example, by a servo motor.

The hydraulic power system 14 may include a boost circuit associated with the pump that can operate to boost the pressure of the hydraulic fluid that is directed to the input side of the pump 20. As shown in FIG. 2, the boost circuit can include a boost pump 32, check valves 34 and 36 and a boost circuit relief valve 38 that discharges to a sump 40. In a known manner, the boost circuit may interact with a bleeding block to control the low pressure line in the hydraulic power system 14. As noted previously, the low pressure line is typically going to be first passageway 26, which is the return line from the motor 22, however under certain operating conditions, the second passageway 24 may be the low pressure line. In this case, the bleeding block can include a shuttle valve 42 and a bleeding block relief valve 10 that is configured to discharge to the sump 40.

In some situations, it may be possible for the pressure of the fluid discharged by the pump 20 to exceed an acceptable threshold value. If unaccounted for, these high pressures could result in damage to the hydraulic power system 14. As shown in FIG. 2, in order to help minimize damage and ensure predictable operation of the machine 10, a first cross-over pressure relief valve 46 may be situated to selectively direct pressurized fluid from the pump 20 to bypass the motor 22 (i.e., to direct fluid from the high pressure first passageway 24 to the low pressure second passageway 26, without the fluid passing through the motor 22) via a first bypass passageway 48. Additionally, to account for situations in which the second fluid passageway 26 is the high pressure side of the hydraulic system (e.g., when the system is operating in reverse), a second cross-over pressure relief valve 50 may be provided that is situated to selectively direct pressurized fluid from the, in this case high pressure, second fluid passageway 26 to the lower pressure first passageway 24 via a second bypass passageway 52.

Although illustrated as pilot operated, spring biased, valve mechanisms, it is contemplated that the cross-over pressure relief valves 46, 50 could alternatively embody an electronic valve actuated in response to a measured pressure, if desired. Additionally, the pressure limit of the pressure relief valves may be variable, and may also be adjustable.

In the hydraulic power system 14, any fluid flow that discharges from the hydraulic pump 20, but does not end up being used to generate speed of the hydraulic motor 22 may be considered as non-productive hydraulic fluid flow. The non-productive hydraulic fluid flow includes any fluid flow through the first and second bypass passageways 48, 52 as a result of operation of either of the cross-over pressure relief valves 46, 50. The non-productive hydraulic fluid flow in the hydraulic power system 14 may also include losses in the system as a result of leakage. For example, leakage in the system may be generated by clearances between the pistons and bores of the pump 20 and motor 22, and of any associated valves.

A control system 53 including a controller 54 with associated sensors may be provided to facilitate operation of the hydraulic power system 14. As schematically shown in FIG. 2, the controller 54 may be in communication with the operator input device 18, the pump 20, the motor 22, a pump speed sensor 56, a motor speed sensor 58, a hydraulic fluid temperature sensor 60 and a power source speed sensor 62. Additional sensors may also be provided including, for example, a pressure sensor that is configured for monitoring hydraulic fluid pressure in the hydraulic power system. The temperature sensor 60 may be configured to monitor temperature of hydraulic fluid and may be located anywhere within the hydraulic circuit. For example, the temperature sensor 60 may be configured to monitor the temperature of the hydraulic fluid within the sump 40, as shown in FIG. 2.

The controller 54 may be further configured to generate control signals for regulating operation of the pump 20 and the motor 22. More particularly, the controller 54 may be configured to control displacement of the pump 20 and the motor 22 by, for example, controlling a pump actuator device 64 (e.g., a solenoid and spool valve) to vary the displacement of the pump 20. Additionally, the pump actuator device 64 may provide information to the controller about actual or commanded displacement of the pump 20. Similarly, the displacement of the motor 22 may also be controlled by a motor actuator device 66. The motor actuator device 66 may also provide information to the controller about actual or commanded displacement of the motor 22. The controller 54 may control displacement of the pump 20 and motor 22 based on information received from the operator input device 18 and the various sensors. The controller 54 may be in communication with the operator input device 18, pump 20, motor 22 and sensors via control lines, which may carry digital, analog, or mixed types of signals. Alternatively, communication with the various components may be implemented by mechanical or hydraulic lines.

The controller 54 may embody a single microprocessor or multiple microprocessors . Numerous commercially available microprocessors may be configured to perform the functions of the controller 54. It should be appreciated that the controller 54 may readily embody a general machine microprocessor capable of controlling numerous machine functions. Various other circuits may be associated with the controller 54, such as power supply circuitry, signal conditioning circuitry, data acquisition circuitry, signal output circuitry, signal amplification circuitry, and other types of circuitry known in the art.

The hydraulic power system 14 may be able to tolerate at least some flow through the cross-over relief valves 46, 50 under at least some operating conditions and for at least some period of time. In such circumstances, it may be possible to regulate operation of the pump 20 and the motor 22, and thereby control the power delivered to, in this case, the traction device 16 of the machine 10, via the controller 54 based on the flow across the cross-over pressure relief valve 46, 50 in the system, which may be referred to as non-productive flow. The control based on flow across the cross-over pressure relief valve 46, 50 may be in addition to or instead of a conventional EPOR system based on system hydraulic fluid pressure.

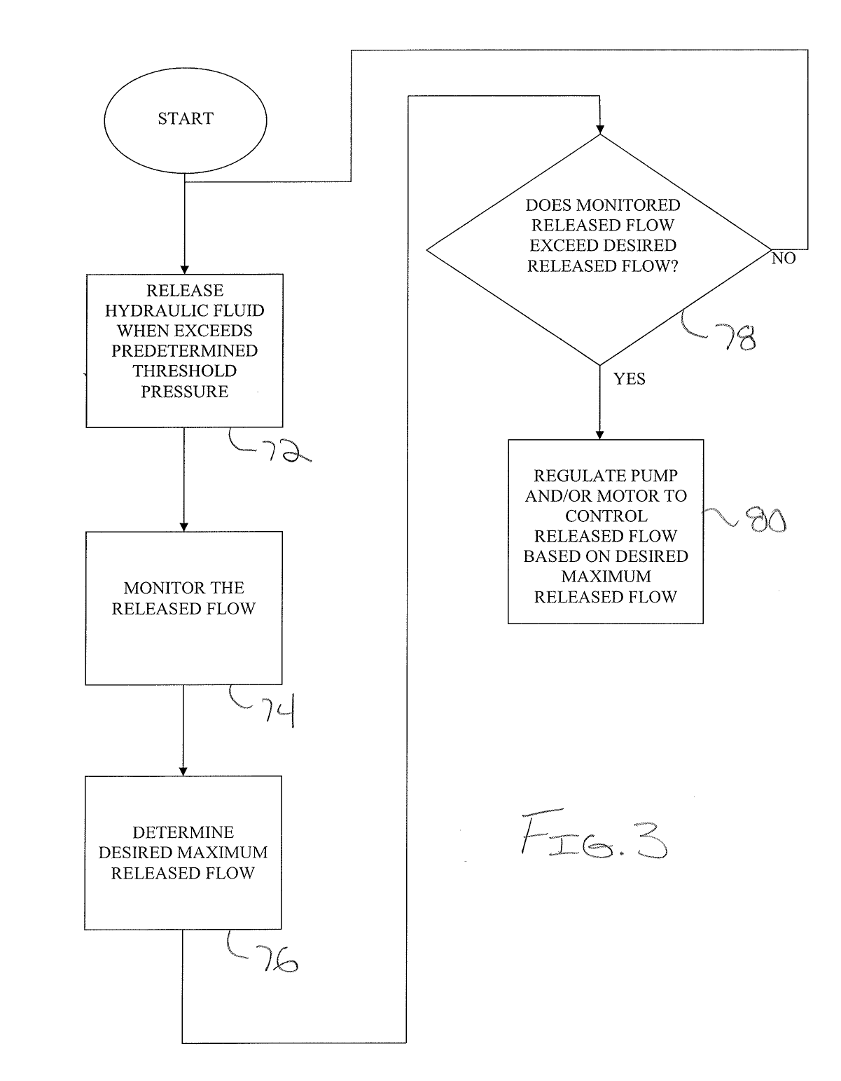

Referring to FIG. 3 of the drawings, a schematic flow diagram is provided that includes various steps that may be included in the non-productive flow based control system for the hydraulic power system 14 and may be implemented by the controller 54. In an initial step (block 72), hydraulic fluid is released at a location between the pump 20 and the motor 22 when the pressure of the hydraulic fluid exceeds a predetermined amount. In the hydraulic power system 14 illustrated in FIG. 2, the releasing is performed by the cross-over pressure relief valves 46 or 50 and the released hydraulic fluid is directed from the high pressure side of the side of the hydraulic circuit to the low pressure side of the hydraulic circuit via either the first or second fluid bypass passageways 48 or 52.

In a further step shown in FIG. 3, a the flow of hydraulic fluid across the cross-over pressure relief valve 46, 50 is monitored in block 74. The monitoring of the of the hydraulic fluid flow across one or both of the cross-over pressure relief valves 46, 50 may be implemented by the controller 54. More specifically, the hydraulic fluid flow across the cross-over pressure relief valve 46, 50 may be determined based on an actual measurement of flow across the valves or it may be determined based on an estimate of the flow across the valves. For example, the controller 54 may monitor the flow across the cross-over pressure relief valve 46, 50 based on a difference in the flow of hydraulic fluid produced by the pump 20 and the flow of hydraulic fluid that is used to generate speed of the motor 22. In other words, the flow across the pressure relief valve 46, 50 could be monitored by monitoring the amount of hydraulic fluid flow produced by the pump 20 that is not used to generate speed of the motor 22. This may be estimated or measured by the controller 54 using readings provided by one or more sensors in the system. For instance, it could be determined by doing a flow balance of the hydraulic power system 14 using the measured pump speed (e.g., from sensor 56), measured or commanded pump displacement (e.g., via pump actuator device 64), measured motor speed (e.g., from sensor 58) and measured or commanded motor displacement (e.g., via motor actuator device 66). Such a calculation may also include some amount of system leakages in addition to fluid flow across the cross-over relief valve 46, 50. However, for purposes of this disclosure, the calculation would provide a reasonable estimate of flow across the cross-over pressure relief valve. The amount of flow across the cross-over pressure relief valve 46, 50 could also be measured or estimated using a method that includes the use of software maps stored within the controller 54 that estimate the flow of hydraulic fluid through the cross-over relief valve 46, 50 based on one or more operating conditions of the hydraulic power system 14.

A further step of the method shown FIG. 3 involves determining a desired maximum flow across the cross-over pressure relief valve 46, 50 in block 76. Again, this step may be implemented by the controller 54. To this end, the controller 54 may include one or more software maps stored within an internal memory thereof that the controller 54 may reference during operation. Each of the maps may include a collection of data in the form of tables, graphs or equations. The desired maximum level of flow across the cross-over pressure relief valve 46, 50 may be determined in a variety of different ways. For example, continued flow across the cross-over relief valve 46, 50 can cause heating of the hydraulic fluid due to the pressure drop of the fluid as it passes from the high pressure side of the system to the low pressure side of the system. This build-up of heat may adversely affect operation of the hydraulic power system at some point. Accordingly, the desired maximum amount of flow across the cross-over pressure relief valve 46, 50 may be determined based on an estimated temperature of the hydraulic fluid in the circuit. The estimate of loop temperature may be based on various operating parameters of the hydraulic power system 14 which may include the temperature of the hydraulic fluid in the sump 40 (e.g., via sensor 60), the displacement and/or speed of the pump 20, and the displacement and/or speed of the motor 22. Such a control could be a closed loop temperature limit control that would automatically adjust the desired maximum flow across the cross-over pressure relief valve 46, 50 as the operating conditions of the hydraulic power system 14 changed.

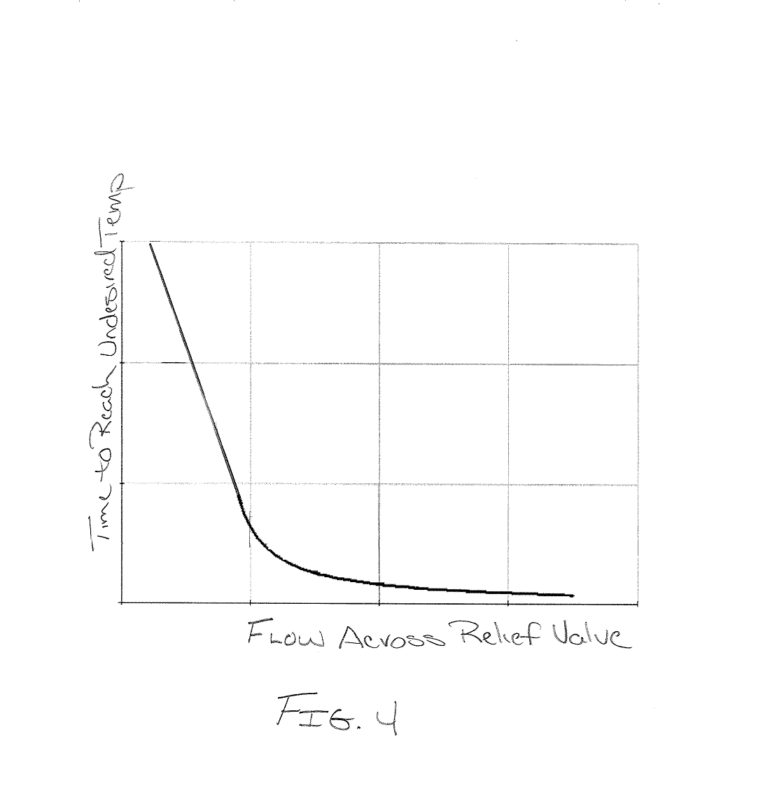

Another method by which the desired maximum level of flow across the cross-over pressure relief valve 46, 50 may be determined is based on a measured temperature of the hydraulic fluid in the sump 40, in this case, via temperature sensor 60. For example, a control map may be provided in the software of the controller 54 based on measurements in a test environment of the sump temperature for a given level of flow across the cross-over pressure relief valve 46, 50. The control map may provide a maximum flow across the cross-over pressure relief valve for a measured sump temperature and from that the controller 54 may select a lower flow across the cross-over relief valve for other reasons such as fuel savings. An example of a plot for such a control map is shown in FIG. 4. In FIG. 4, the x-axis represents the amount of flow across the cross-over pressure relief valve and the y-axis represents that amount of time for the hydraulic fluid to reach what may be considered as an undesirably high hydraulic fluid temperature for a given sump temperature. As shown, in the plot, at lower levels of flow across the cross-over pressure relief valve the time until the temperature of the hydraulic fluid reaches an undesirable level is longer than at higher levels of flow across the cross-over relief valve. Additional plots may be provided for different sump temperatures. For example, if the sump is starting at a lower temperature than in the plot shown in FIG. 4, the curve may be shifted to the right because it should take longer for the hydraulic fluid to reach an undesirable temperature for a given flow across the cross-over relief valve. Thus, control of the system can be based on a flow control model, rather than a pressure limiting model, based on allowing some temperature rise in the circuit for a period of time. Once that period of time is up the system can be adjusted to lower the flow across the cross-over relief valve. This can be done using the same flow control approach or a pressure limiting approach may be implemented at that time.

Another method by which the desired maximum level of flow across the cross-over pressure relief valve 46, 50 may be determined is based on an operating mode of the machine 10 that is, for example, selected by an operator and input to the controller 54. The operating modes may, for example, include a high efficiency mode and a high performance mode. In the high efficiency mode, the controller 54 would set the desired maximum flow across the cross-over pressure relief valve 46, 50 at a low level or in the most extreme condition at zero. In the high performance mode, the controller 54 would set the desired maximum flow across the cross-over pressure relief valve at a high level or in the most extreme condition at the maximum flow that can be produced by the power source 12. In order to avoid over-heating of the system in the high performance mode, the controller 54 may be configured such that the operator can only select the high performance mode when the temperature of the hydraulic fluid is low to intermediate.

Once the actual flow across the cross-over pressure relief valve 46, 50 is monitored and the desired maximum flow across the cross-over pressure relief valve 46, 50 is determined, the controller 54 can then compare the desired maximum flow with the actual flow in block 78 and then regulate one or both of the pump 20 and the motor 22 to control the flow across the cross-over pressure relief valve 46, 50 based on the desired maximum flow in block 80. In the embodiment disclosed in FIG. 3, the desired maximum flow across the cross-over pressure relief valve 46, 50 is a maximum flow. Thus, if the monitored flow across the cross-over pressure relief valve does not exceed the flow across the cross-over pressure relief valve 46, 50, the controller 54 circles back to before block 72 and the process may be repeated. If the monitored flow across the cross-over pressure relief valve 46, 50 does exceed the desired maximum flow then the controller 54 regulates the pump 20 and/or motor 22, for example, by adjusting one or more of their associated operating parameters. For instance, typically when the machine 10 is operating to push a load, if the monitored flow across the cross-over relief valve exceeds the desired maximum flow, the displacement of the pump 20 may be reduced. However, under such circumstances, it may be possible for the controller 54 to increase the displacement of the motor 22 if it is not already at maximum displacement or the controller 54 may execute a combination of decreasing the pump displacement and increasing the motor displacement.

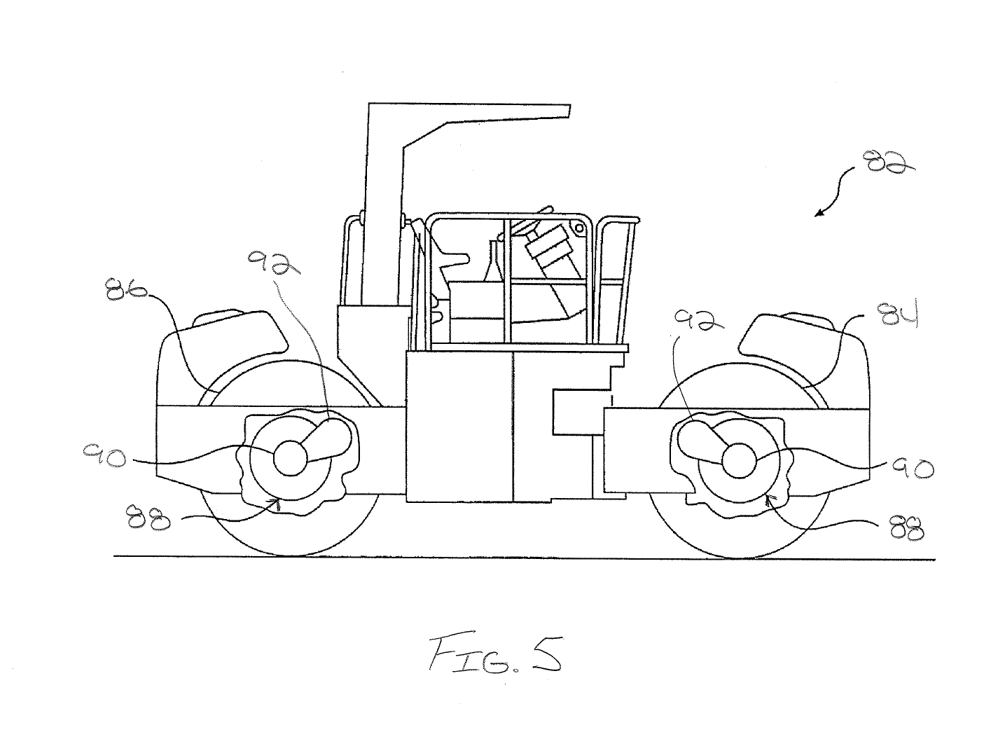

While the embodiments of FIGS. 2 and 3 have been described in connection with a hydraulic power system 14 that drives a traction device of a wheeled vehicle, as noted above, such embodiments are equally applicable to hydraulic power systems 14 that drive other loads. One example is a hydraulic power system 14 that drives a vibratory mechanism of a machine such as a compactor. Referring to FIG. 5 of the drawings, a double-drum compactor 82 used for compacting a material such as soil, gravel, or asphalt to increase the density of the material is shown. While a double-drum compactor 82 is described, the compactor 82 could have with more or less than two drums. The illustrated compactor 82 has a first compacting drum 84 and a second compacting drum 86 rotatably mounted on a main frame. In this case, each compacting drum 84, 86 includes a respective vibratory mechanism 88. Each vibratory mechanism 88 includes weights 92 arranged on a shaft 90 rotatable about a common axis within an interior cavity of the drum for inducing vibrations on the drum.

The rotation of the vibratory mechanisms for the two drums can be driven by a single or respective hydraulic power system 14 such as shown in FIG. 2. Moreover, control of the hydraulic power system 14 can be based on flow across the cross-over pressure relief valve such as with the system shown in FIG. 2 and the method as shown in FIG. 3. When using the hydraulic power system 14 to drive a vibratory mechanism 88, the cross-over relief valves 46 or 50 can open and direct hydraulic fluid through the bypass passages 48, 52 when the associated vibratory mechanism 88 achieves maximum acceleration such as during start-up. Each time one of the pressure relief valves 46 or 50 opens, the efficiency of the hydraulic power system may be reduced. That is, because the fluid being relieved has already been pressurized, energy that was used to pressurize that fluid is wasted. This wasted energy may result in a greater amount of fuel being consumed by and require more power from the power source 12. On the other hand, reducing the pressure in the system using a pressure control scheme to a level below which the cross-over relief valves 46 or 50 open would result in the system producing less than maximum acceleration of the vibratory mechanism particularly as such a pressure control system may be difficult to tune precisely. Regulating operation of the pump 20 and motor 22 of the hydraulic power system 14 based on a desired maximum flow across the cross-over pressure relief valve, such as described above with reference to FIGS. 2 and 3, can enable the system to provide maximum acceleration of the vibratory mechanism 88 with a minimal flow across the cross-over relief valves 46 or 50 that minimizes consumption of fuel and excessive heat build-up in the system.

### INDUSTRIAL APPLICABILITY

The hydraulic power control system and method described herein may be implemented in a variety of different machines that utilize hydrostatic transmissions to power movement of the machine or operation of an implement that is connected to the machine. The disclosed control system and method may be particularly suitable to applications in which, under at least some operating conditions ,some amount of flow over a cross-over relief valve can be maintained without excessive heating of the hydraulic fluid in the system.

As compared to control systems that operate based on pressure of the hydraulic fluid in the system, the disclosed control system and method based on flow across the cross-over relief valve or non-productive flow may provide a more consistent, intuitive feel to an operator of the machine because it is easier to tune and will not be subject to the overshooting issues associated with pressure based control systems that may make an operator feel as if the machine has suddenly stopped pushing. Moreover, as compared to pressure based control systems, a control scheme based on flow across the cross-over pressure relief valve may allow the hydraulic power system to operate more closely to its maximum capable performance, at least under certain operating conditions. For instance, with respect to the start-up of the vibratory mechanism of a compactor, the disclosed control system and method may enable the vibratory mechanism to achieve a higher maximum acceleration while conserving fuel. In particular, the amount of energy required to start the vibratory system can vary depending upon whether the operator selects a single drum, both drums or different amplitude settings of the drums. Using the disclosed system or method will enable the system to provide the energy required regardless of the drum settings.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A hydraulic power control system for a machine comprising:
a hydraulic motor;
a hydraulic pump configured to supply hydraulic fluid to the hydraulic motor;
a relief valve configured to release hydraulic fluid from a location between the hydraulic pump and the hydraulic motor when a pressure of the hydraulic fluid exceeds a predetermined pressure; and
a controller in communication with the hydraulic motor and the hydraulic pump, the controller being configured to:
determine a first hydraulic fluid flow across the relief valve;
determine a desired maximum flow across the relief valve; and
regulate one or both of the hydraulic pump and the hydraulic motor to control the first hydraulic fluid flow based on the desired flow.

2. The system of claim 1 wherein the controller determines the desired maximum flow across the relief valve based on a temperature of the hydraulic fluid.

3. The system of claim 1 further including a vibratory mechanism operatively connected to the hydraulic motor.

4. The system of claim 1 further including a traction device operatively connected to the hydraulic motor.

5. The system of claim 1 wherein the hydraulic pump and the hydraulic motor are each configured to have variable displacement.

6. The system of claim 5 wherein the controller regulates one or both of the hydraulic motor and hydraulic pump by adjusting one or both of their respective displacements.

7. The system of claim 1 wherein the controller determines the first hydraulic fluid flow using a speed and a displacement of the hydraulic pump and a speed and displacement of the hydraulic motor.

8. The system of claim 1 wherein the controller determines the desired maximum flow across the relief valve based on an operating mode of the machine.

9. A method of controlling a hydraulic power system for a machine comprising:
releasing hydraulic fluid from a location between a hydraulic pump and a hydraulic motor when the pressure of the hydraulic fluid exceeds a predetermined threshold pressure;
monitoring a first flow of released hydraulic fluid;
determining a desired maximum flow of released hydraulic fluid ; and
regulating one or both of the hydraulic pump and the hydraulic motor to control the first flow based on the desired maximum flow.

10. The method of claim 9 further including the step of monitoring a temperature of the hydraulic fluid in the system.

11. The method of claim 10 wherein the desired maximum flow of released hydraulic fluid is determined based on the temperature of the hydraulic fluid in the system.

12. The method of claim 9 wherein one or both of the hydraulic motor and hydraulic pump are regulated by adjusting one or both of a respective displacements of one or both of the hydraulic motor and the hydraulic pump.

13. The method of claim 9 wherein the first flow is determined using a speed and a displacement of the hydraulic pump and a speed and displacement of the hydraulic motor.

14. The method of claim 9 wherein the controller the desired maximum flow of released hydraulic fluid is determined based on an operating mode of the machine.

15. A machine comprising:
a load;
a power source;
a hydraulic motor operatively connected to the load;
a hydraulic pump operatively connected to the power source and configured to supply hydraulic fluid to the hydraulic motor;
a relief valve configured to release hydraulic fluid from a location between the hydraulic pump and the hydraulic motor when a pressure of the hydraulic fluid exceeds a predetermined pressure; and
a controller in communication with the hydraulic motor and the hydraulic pump, the controller being configured to:
determine a first hydraulic fluid flow across the relief valve;
determine a desired maximum flow across the relief valve; and
regulate one or both of the hydraulic pump and the hydraulic motor to control the first hydraulic fluid flow based on the desired flow.

16. The machine of claim 15 wherein the controller determines the desired maximum flow across the relief valve based on a temperature of the hydraulic fluid.

17. The machine of claim 15 wherein the load is a vibratory mechanism.

18. The machine of claim 15 wherein the load is a traction device.

19. The machine of claim 15 wherein the controller regulates one or both of the hydraulic motor and hydraulic pump by adjusting one or both of their respective displacements.

20. The machine of claim 1 wherein the controller determines the desired maximum flow across the relief valve based on an operating mode of the machine.
